(19) United States
(12) Patent Application Publication
(10) Pub. No.: US 2022/0281478 A1
(43) Pub. Date: Sep. 8, 2022

(54) MOTION MONITORING SAFETY DIAGNOSTIC FOR THE DETECTION OF ERRONEOUS AUTONOMOUS MOTION REQUESTS

(71) Applicants: Steering Solutions IP Holding Corporation, Auburn Hills, MI (US); Continental Automotive Systems, Inc., Auburn Hills, MI (US)

(72) Inventors: Varunraj Arunrao Shedge, Auburn Hills, MI (US); Scott A. Millsap, Grand Blanc, MI (US); Joseph A. LaBarbera, Auburn Hills, MI (US); Omkar Karve, Farmington Hills, MI (US)

(21) Appl. No.: 17/590,892

(22) Filed: Feb. 2, 2022

Related U.S. Application Data
(60) Provisional application No. 63/155,528, filed on Mar. 2, 2021.

(51) Int. Cl. B60W 60/00; B60W 50/04; B60W 50/02

(52) U.S. Cl. CPC B60W 60/0015; B60W 50/04; B60W 50/0205; B60W 2050/041; B60W 2050/022

(57) ABSTRACT

In a number of illustrative variations, a method may include providing a first motion control algorithm and a second motion control algorithm, the first motion control algorithm and a second motion control algorithm being constructed and arranged to provide motion control requests. The method may further include determining if the first motion control algorithms motion control requests are within a plausible range and performing a switchover from the first motion control algorithm to the second motion control algorithm if necessary.

### CROSS-REFERENCE TO RELATED APPLICATIONS

This application claims the benefit of U.S. Provisional Application Ser. No. 63/155,528 filed Mar. 2, 2021.

### TECHNICAL FIELD

The field to which the disclosure generally relates to includes motion control systems as part of autonomous driving systems.

### BACKGROUND

Vehicles may include autonomous driving and steering systems typically associated with “self-driving vehicles” that may include lane-keeping assist systems, lane centering systems, or traffic assist systems that may plan the trajectory of a vehicle based on data gathered from internal or external sources in addition to other functions. In some operational scenarios, it may be required to continue the driving mission with the existence of a system fault or a known degraded capability. Support for continuous operation of autonomous driving system may be required until a safe vehicle state can be attained. At least one algorithm may dictate motion control function for an autonomous driving system, and in some instances, the at least one algorithm may dictate faulty motion controls._{[SM1][KB2]}

Software monitoring and diagnostics in a motion control system may be used to identify faulty motion control commands originating from a first algorithm in an autonomous driving vehicle and perform a switchover from the first algorithm to a second algorithm not providing faulty motion control commands, such that the function, safety, and value of the motion control system itself is improved considerably.

### SUMMARY OF ILLUSTRATIVE VARIATIONS

A number of illustrative variations may include a method or product for managing motion control requests in an autonomous driving system.

A method may include providing a first motion control algorithm and a second motion control algorithm, the first motion control algorithm and a second motion control algorithm being constructed and arranged to provide motion control requests. The method may further include determining if the first motion control algorithm's motion control requests are within a plausible or acceptable range and performing a switchover from the first motion control algorithm to the second motion control algorithm.

A product may include a first motion control algorithm and a second motion control algorithm, the first motion control algorithm and a second motion control algorithm being constructed and arranged to provide motion control requests; a motion monitoring diagnostic module; a functional safety manager module; and a motion control request arbitration module constructed and arranged to determine if the first motion control algorithm's motion control requests are within a plausible or acceptable range in cooperation with information received from the motion monitoring diagnostic module and the functional safety manager module.

A product may include a first motion control algorithm and a second motion control algorithm, the first motion control algorithm and a second motion control algorithm being constructed and arranged to provide motion control requests; a motion control path planner constructed and arranged to communicate trajectory commands to at least one of the first motion control algorithm or the second motion control algorithm; a functional safety manager module; a motion monitoring diagnostic module constructed and arranged to determine vehicle motion plausibility data and communicate the vehicle motion plausibility data to the functional safety manager module; and a motion control request arbitration module constructed and arranged to determine if the first motion control algorithm's motion control requests are within a plausible or acceptable range.

Other illustrative variations within the scope of the invention will become apparent from the detailed description provided hereinafter. It should be understood that the detailed description, while disclosing variations of the invention, is intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts an illustrative variation of a motion monitoring safety diagnostic system;

FIG. 2 depicts an illustrative variation of a portion of a motion monitoring safety diagnostic system;

FIG. 3 depicts an illustrative variation of a portion of a motion monitoring safety diagnostic system; and

FIG. 4 depicts an illustrative variation of a portion of a motion monitoring safety diagnostic system.

### DETAILED DESCRIPTION OF ILLUSTRATIVE VARIATIONS

The following description of the variations is merely illustrative in nature and is in no way intended to limit the scope of the invention, its application, or uses.

In a number of illustrative variations, a vehicle for cargo or passengers may be driven by an automotive power derived from a motor that transforms a source of stored energy into a driving force for the vehicle such as, but not limited to, an internal combustion engine, a battery powered engine, a fuel-cell powered engine, or any other known motor for providing automotive driving power for a passenger or cargo vehicle. The driving force that results from the transformation of stored energy by the motor may be communicated from the motor to a driving medium along which the vehicle will travel such as, but not limited to, a tract of land, a road, a waterway, an airway, or any other medium along which vehicles are known to travel through space. The communication of the driving force from the motor to the driving medium may occur via any means of driven automotive vehicle movement such as but not limited to road wheels, treads, casters, rollers, propellers, gas thrusters, liquid thrusters, or ion driven thrusters, or any other known means of driven automotive vehicle movement.

In a number of illustrative variations, a vehicle may have a steering system that allows a driver to change the vehicle's direction or divert it from a path that it may be traveling in. This steering system may operate in conjunction with a source of driven automotive vehicle movement such as a pair of driven road wheels. As a non-limiting example, a vehicle may be equipped with an internal combustion engine that mechanically drives a pair of rear road wheels to propel the vehicle forward along a road. In such an example, the vehicle may additionally be equipped with a set of steerable front road wheels that may be manipulated by the steering system via a steering interface such as but not limited to a hand wheel to steer the vehicle to the left and to the right as the vehicle travels down the road. In such an example, the driven rear road wheels serve as the means of driven automotive vehicle movement, and the steerable pair of front road wheels as manipulated by the steering interface serves as the steering system. This is not the only means by which a vehicle is contemplated as being driven or steered in this disclosure. In a number of illustrative variations, the front road wheels may be the driven road wheels as well as the steerable road wheels. Similarly, the means of driven automotive vehicle movement does not need to be of the same kind as the steering means. That is, if the means of driven automotive vehicle movement includes road wheels, the steering means does not need to also include road wheels. As a non-limiting example, it is contemplated that a snowmobile may be driven by a set of treads and steered by a set of steerable skis. Additionally, it is contemplated that the means of driven automotive vehicle movement, such as but not limited to driven road wheels, and the steering means, such as but not limited to steerable road wheels, may change function or oscillate in function while in operation. As a non-limiting example, a vehicle comprising a pair of driven road wheels near the rear of the vehicle and further comprising a pair of steerable road wheels near the front of the vehicle may change driving modes and begin to utilize every road wheel available, including the front steerable road wheels, as driven road wheels while still maintaining the steerable property and steering function of the front steerable road wheels. It is similarly contemplated that driven road wheels may be intermittently or optionally used as steerable road wheels in some cases.

A vehicle may include a steering system comprising a steering interface, and a set of steerable roadwheels. The steering system may be of the electric power steering type wherein physical linkages mechanically communicate a manipulation of the steering interface to the steerable wheels. The steering system may be of the steer-by-wire type wherein physical mechanisms do not mechanically communicate a manipulation of the steering interface to the steerable roadwheels and wherein a manipulation of the steering interface affects an associated manipulation of the steerable roadwheels via the communication of electronic devices such as but not limited to sensors, transceivers, and actuators. The steering interface may be automatically manipulated by an autonomous steering system by use of electric or mechanical motors, actuators, magnets, or any other method known in the art. At least one algorithm may dictate motion control function, such as steering angle or steering torque requests, for the autonomous driving system, the autonomous steering system, and a steering actuation system. The at least one algorithm may dictate faulty motion controls. Motion monitoring safety diagnostics may be used to identify faulty motion control requests originating from a first algorithm in an autonomous driving vehicle.

An autonomous driving path planner or motion control path planner may diagnose and alert a motion control system if a planned or calculated trajectory is incorrect or unavailable. A trajectory arbitration module may receive primary and secondary, or redundant path trajectory data from an external autonomous driving planner. The trajectory arbitration module may evaluate the validity status of the redundant trajectories, perform a gross plausibility check on the received trajectory data set, and determine the appropriate error free trajectory to be supplied to the primary or secondary motion control algorithms. In some cases, the motion control system may not account for planned or calculated trajectories which may be erroneous due to corruption or frozen due to communication transmission faults. Redundant trajectories may therefore be provided to the motion control system such that the motion control function can continue computing motion requests if a current trajectory is detected as corrupted or invalid. The motion control system may be responsible for arbitrating and transitioning to an error-free received trajectory based upon a diagnostic status provided from a communications software layer. The status of the arbitration result may also be provided as an output for diagnostic evaluation.

A motion control system in an autonomous driving system may assist in the control of lateral and longitudinal motion of a vehicle. The motion control system may receive vehicle data and autonomous driving coordination data from vehicle level control systems and convert said data into steering, braking, and propulsions requests. The motion control system may include a number of modules constructed and arranged to perform functions such as motion path planning, trajectory planning, motion monitoring, safety monitoring, request arbitration, and output plausibility and plausibility diagnostics, among other functions. Output plausibility and plausibility diagnostics may include diagnosing system faults by monitoring for errant output behavior or unacceptable output behavior if output behavior does not fall within a predetermined range or within plausible parameters. Motion control management functions may coordinate switchovers between primary, redundant, and diverse motion control algorithms, diagnosing incorrect vehicle motion, reporting health status of actuators and the motion control system, generating safe requests for actuators, and determination of capability of the actuator systems to follow the intended trajectory.

A motion monitoring safety diagnostic may coordinate a switchover from primary motion control requests to fallback motion requests by first diagnosing error conditions in the motion of a vehicle including an autonomous driving system. A motion monitoring safety diagnostic may also apply safety barriers or limits on motion requests produced as outputs of the motion control system. A motion monitor module may provide for the diagnosis of incorrect vehicle motion that may be inconsistent with a provided motion trajectory or which may be caused by a loss of actuator capability. A motion monitor module may receive information such as actuator subsystem's health status from a performance manager. Similarly, the motion monitor module may receive information such as vehicle speed, yaw rate, lateral and longitudinal acceleration, and vehicle local position from a variety of systems and modules. The motion monitoring safety diagnostic may coordinate a switchover from primary motion control requests to fallback motion requests where measured vehicle behavior deviates from acceptable or plausible ranges, particularly where such vehicle behaviors deviates from plausible ranges as a result of faults originating from the primary motion control algorithm, thereby improving the effective function and safety of the motion control system and autonomous vehicle system by reducing errant motion control commands and potential for passenger harm or injury.

A functional safety monitor module may collect diagnostic data from actuation systems within a vehicle and the motion monitoring diagnostic module may then determine if a change or switchover from a primary motion control requests to fallback motion requests or from a primary motion control algorithm to a secondary motion control algorithm is necessary.

A request arbitration module may respond to a switchover request from the functional safety manager module and may perform a transition from the primary motion control requests to fallback motion requests or from a primary motion control algorithm to a secondary motion control algorithm.

A motion safety manager may consolidate and analyze actuator health status and motion control system health status. By analyzing the different health statuses, the motion safety manager may communicate with an autonomous driving system about the availability of the motion control system and actuator systems. Motion safety manager also may also send information to the motion control request arbitration module to perform the switch between the primary motion control algorithm, secondary motion control algorithm, and any fallback motion control or additional backup motion control algorithm.

A motion plausibility monitor may detect abnormal vehicle motion or motion control requests while a vehicle is under autonomous motion control. Output plausibility and plausibility diagnostics may be used to monitor output responses that can be compared against known, prior outputs, or predicted vehicle behavior to identify abnormalities. If measured vehicle behavior such as vehicle speed, yaw rate, acceleration, steering torque, or the like deviate from acceptable or plausible ranges or predetermined ranges then the primary motion control algorithm may be computing incorrect motion requests leading to errant vehicle behavior. The plausible ranges or predetermined ranges may be based on, but not limited to, acceptable state of health of one or more components of the vehicle, surface condition on which the vehicle drives or travel, or weather conditions. The results of the plausibility diagnostic may be provided to the functional safety management module for further evaluation and determination if a switchover from a primary motion control requests to fallback motion requests or from a primary motion control algorithm to a secondary motion control algorithm is necessary. If measured vehicle behavior such as vehicle speed, yaw rate, acceleration, steering torque, or the like deviate from acceptable or plausible ranges because of faults originating from the primary motion control algorithm, then a switchover from relying on the primary motion control algorithm for motion control requests to relying on the secondary motion control algorithm for motion control requests may occur.

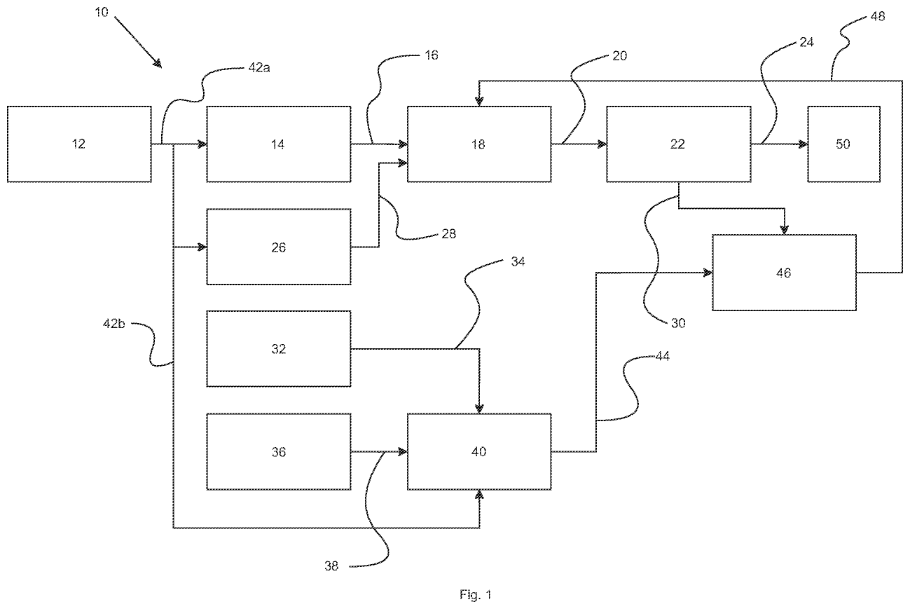

Referring to FIG. 1, an autonomous vehicle driving system 10 may include a motion control path planner 12 that may include a primary motion control algorithm 14 and a secondary motion control algorithm 26. The motion control path planner 12 may communicate motion control commands 42a, 42b to the primary motion control algorithm 14, the secondary motion control algorithm 26, and a motion monitoring diagnostic module 40. The primary motion control algorithm 14 may make motion requests such as controlling or adjusting steering angle, braking, and propulsion of an autonomous or semi-autonomous vehicle. The primary motion control algorithm 14 may make primary motion requests 16 to a motion control request arbitration module 18. The secondary motion control algorithm 26 may make secondary motion requests 28 to a motion control request arbitration module 18. The motion control request arbitration module 18 may arbitrate motion requests 20 and a safety limiter module 22 may apply motion control request safety limits 30. Final motion request commands 24 may be delivered to at least one actuator 50.

The safety limiter module 22 may also communicate with a functional safety manager module 46. The motion monitoring diagnostic module 40 may determine vehicle motion plausibility data 44 and communicate the vehicle motion plausibility data to the functional safety manager module 46 which may communicate motion control diagnostic statuses 48 to the motion control request arbitration module 18. The safety limiter module 22 may include a software safety mechanism which supports the motion control system's safety concept by applying dynamic safety limits upon the motion control requests to constrain the potential fault energy that may be reaching actuators.

A performance manager module 32 may communicate information such as actuator subsystems health status 34 to a motion monitoring diagnostic module 40. A vehicle dynamic response data module 36 may communicate vehicle responses 38 such as vehicle speed, yaw rate, lateral and longitudinal acceleration, and vehicle local position to the motion monitoring diagnostic module 40. The motion monitoring diagnostic module 40 may utilize information received from the performance manager module 32 and the vehicle dynamic response data module 36 to determine vehicle motion plausibility status 44. Vehicle motion plausibility status 44 may include data relating to the likelihood of motion requests such as adjusting steering angle, braking, and propulsion of an autonomous or semi-autonomous vehicle being made by the primary motion control algorithm 14 or the secondary motion control algorithm 26. The motion control request arbitration module 18, in cooperation with information received from the motion monitoring diagnostic module 40 and the functional safety manager module 46 may determine or identifying motion control requests unusual, unsafe, outlier, or otherwise faulty motion control requests originating from the primary motion control algorithm 14. Where a fault within the primary motion control algorithm 14 or the primary motion control requests is determined, the autonomous vehicle driving system 10 including a motion control path planner 12 may switchover from relying on the primary motion control algorithm 14 for motion control requests to relying on the secondary motion control algorithm 26 for motion control requests.

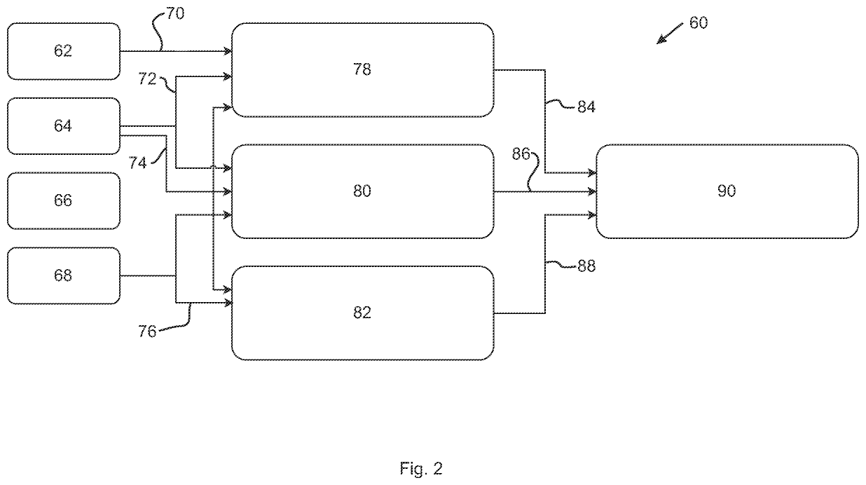

Referring to FIG. 2, an autonomous vehicle driving system 10 may include a motion control plausibility monitor 60 that may perform a vehicle trajectory error check module 78, a predictive vehicle dynamic check module 80, and a vehicle dynamic threshold check module 82. The motion control plausibility monitor 60 may receive ego position data 62, trajectory data 64, motion request arbitration status 66, and vehicle dynamic signals 68.

The vehicle trajectory error check module 78 may receive ego position data 62, trajectory data 64, and may be in communication with the vehicle dynamic threshold check module 82. The vehicle trajectory error check module 78 may use the received ego local position data 62 and trajectory data 64 provided by the motion planner to compute deviations from the planned path. Where the primary motion control algorithm is producing correct requests and the motion control system is receiving healthy status for the actuators, the motion controller may regulate the vehicle's motion to minimize these deviations. Predetermined thresholds for excessive deviations from the requested trajectory may be established. If excessive deviations are occurring when valid trajectory data 64 and ego local position data 62 is received along with healthy actuators, then the primary motion control algorithm may be computing erroneous motion requests. Motion plausibility trajectory error status may be communicated 84 to the motion plausibility diagnostic status module 90.

The predictive vehicle dynamic check module 80 may receive trajectory data 64 as arbitrated trajectory data 72 and trajectory validity status 74. The predicted vehicle dynamic check module 80 may also receive vehicle dynamics signals 68 in the form of vehicle dynamic data 76. The predicted vehicle dynamic check module 80 may utilize a physics-based strategy to determine if the vehicle trajectory provided to the motion controller will result in plausible vehicle motion. Estimation of vehicle responses may be provided from a vehicle dynamics model implemented within the predictive vehicle dynamic check module 80. Motion plausibility predictive vehicle dynamic status may be communicated 86 to the motion plausibility diagnostic status module 90.

The vehicle dynamic threshold check module 82 may receive vehicle dynamic signals 68 in the form of vehicle dynamic data 76 and may be constructed and arranged to monitor vehicle dynamic signals on a vehicle network or provided by a dedicated inertial measurement unit (IMU) installed within a vehicle. Within the scope of the autonomous driving use cases, it is anticipated that the motion planner may request driving trajectories that will maintain the vehicle dynamic responses within a typical range for reasons such as passenger comfort, road, or other environmental conditions. Predetermined vehicle dynamic thresholds may be established, that if exceeded for certain durations, may indicate a concern for safe vehicle operation. Predetermined vehicle dynamic thresholds may include maximum lateral or longitudinal acceleration (deceleration) tailored for specific vehicle speed ranges or motion trajectory types. Additional predetermined vehicle dynamic thresholds may include maximum yaw rate response for the planned vehicle heading and curvature of the requested trajectory. Predetermined vehicle dynamic thresholds may be evaluated for an excessive condition and reported 88 to a motion plausibility diagnostic status module 90.

The motion plausibility diagnostic status module 90 may consolidate and analyze actuator health status and motion control system health status in addition to arbitrating motion plausibility diagnostic status results. By analyzing the different health statuses, the motion plausibility diagnostic status module may inform an autonomous driving system about the availability of the motion control system and actuator systems. The motion plausibility diagnostic status module also may also send information to the motion safety manager regarding motion plausibility status and detected faults.

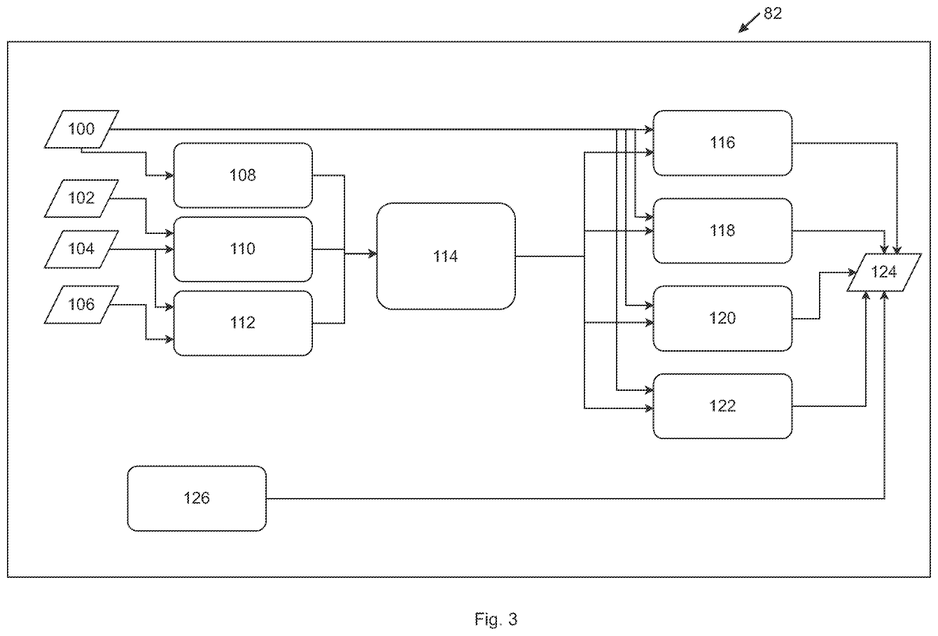

Referring to FIG. 3,_{[SM3][SM4]} an autonomous vehicle driving system 10 may include a vehicle dynamic threshold check module 82 constructed and arranged to test vehicle dynamic response signals which may exceed an expected normal threshold. Threshold may be dynamically commuted to adapt to changing signal characteristics, driving situations, and detected changing vehicle or environmental conditions. The vehicle dynamic threshold check module 82 may receive vehicle dynamics data 100, trajectory data 102, autonomous driving system data 104, and road and environmental data 106. The vehicle dynamic threshold check module 82 may use vehicle dynamic data 100 to compute vehicle dynamic signal analysis 108 by identifying patterns in signals such as drift, offset, unexpected peaks. Computing vehicle dynamic signal analysis 108 may include calculating run-time signal averages and provide threshold checks to improve diagnostic robustness. The vehicle dynamic threshold check module 82 may use trajectory data 102 and autonomous driving system data 104 to adapt diagnostic strategy 110 in cases of repetitive driving loops, freeway driving, or similar scenarios. The vehicle dynamic threshold check module 82 may use autonomous driving system data 104 and road and environmental data 106 to identify route and conditional threshold applications 112 including dynamically adjusting diagnostic thresholds based upon driving route and environmental conditions. Other factors such as tired tread life, tire inflation pressure, etc. may be considered in dynamically adjusting diagnostic thresholds.

The results of computing vehicle dynamic signal analysis 108, adaptive diagnostic strategy 110, and identifying route and conditional threshold applications 112 to consolidate and arbitrate adaptive thresholds 114.

Thresholds such as lateral acceleration threshold 116, maximum vehicle speed threshold 118, longitudinal acceleration 120, and yaw rate error threshold 122 may be compared to vehicle dynamic data 110 and consolidated and arbitrated adaptive thresholds 114 and may be compared routinely on a fixed or adaptive interval. For example, the vehicle dynamic threshold check module 82 may check and debounce vehicle dynamic signals against the computed diagnostic thresholds. The results of comparing vehicle dynamic data 110 and consolidated and arbitrated adaptive thresholds 114 may be consolidated 124 and provided to the motion safety manager.

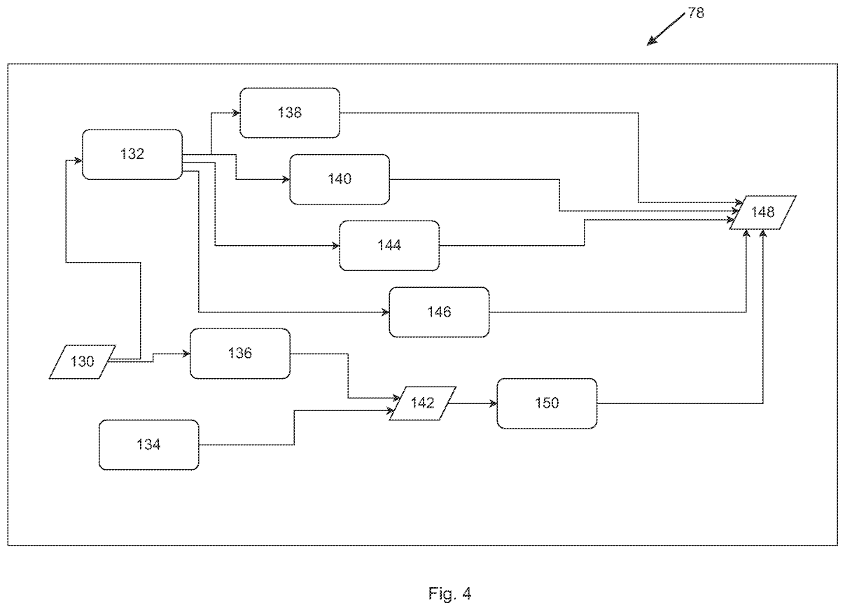

Referring to FIG. 4, an autonomous vehicle driving system 10 may include a trajectory error check module 78 that may calculate deviations from provided trajectory data and ego local position of a vehicle. A trajectory error diagnostic may compare computed errors against a threshold value for instances where the threshold value has been exceeded. The trajectory error diagnostic may temporarily suspend for situations where the deviation error may temporarily increase above a threshold value, for example, where there is no valid trajectory available or where a requested trajectory replan event has occurred. Trajectory data 130 may be provided in the form of a trajectory replanned status. The trajectory error check module 78 may determine 136 if a trajectory replan is requested and suspend monitoring during a trajectory active replan. The trajectory data 130 may also be combined with ego local position data to calculate 132 a dynamic deviation between a provided motion trajectory and current vehicle ego local position. A first check 138 may be performed to determine the rate of change of deviation from an intended lateral path greater than a predetermined threshold. The result of the check 138 may indicate that a vehicle has suddenly moved too far away from an intended path which may be interpreted as motion controller fault. A second check 140 may be performed for lateral deviation from an intended lateral path greater than a predetermined threshold. Where the check 140 has determined that deviation from the intended lateral path is consistently above a predetermined threshold for a predetermined duration then the result may indicate that a motion controller is unable to follow a desired path. A third check 144 may be performed to determine deviation from an intended orientation of vehicle velocity vector greater than a predetermined threshold. Where the check 144 determines that a vehicle's velocity is greater than a predetermined threshold, the check 144 may indicate that a vehicle is deviating from the trajectory in a significant manner. A fourth check 146 may determine deviation from an intended longitudinal velocity from actual vehicle speed. The results of check 138, check 140, check 144, check 146 may be compiled in the motion plausibility trajectory error status 148. The motion plausibility trajectory error status 148 may also receive a suspend vehicle trajectory error check 150. The vehicle trajectory vehicle error check 150 may suspend the trajectory error diagnostic if either a replan or invalid trajectory condition is true as determined 142 according to the check trajectory replan status 136 and the check received trajectory validity status 134. The check received trajectory validity status 134 may determine if the trajectory is invalid such that motion plausibility cannot be evaluated.

The following description of variants is only illustrative of components, elements, acts, product and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, a method may include providing a first motion control algorithm and a second motion control algorithm, the first motion control algorithm and a second motion control algorithm being constructed and arranged to provide motion control requests. The method may further include determining if the first motion control algorithms motion control requests are within a predetermined acceptable or plausible range and performing a switchover from the first motion control algorithm to the second motion control algorithm where the first motion control algorithms motion control requests are determined to not be within the acceptable or plausible range.

Variation 2 may include a method as set forth in variation 1 and may further include defining a plausible range prior to determining if the first motion control algorithms motion control requests are within a plausible range.

Variation 3 may include a method as set forth in any of variations 1 through 2 and may further include providing a motion control path planner constructed and arranged to communicate trajectory commands to at least one of the first motion control algorithm or the second motion control algorithm.

Variation 4 may include a method as set forth in any of variations 1 through 3 and may further include providing a motion control request arbitration module constructed and arranged to arbitrate motion requests made by the at least one of the first motion control algorithm or the second motion control algorithm.

Variation 5 may include a method as set forth in any of variations 1 through 4 and may further include providing at least one actuator subsystem that may include at least one actuator.

Variation 6 may include a method as set forth in any of variations 1 through 5 and may further include providing a safety limiter module and a functional safety manager module constructed and arranged to apply motion control request limits.

Variation 7 may include a method as set forth in any of variations 1 through 6 and may further include providing a motion monitoring diagnostic module constructed and arranged to determine vehicle motion plausibility data and communicate the vehicle motion plausibility data to the functional safety manager module.

Variation 8 may include a method as set forth in any of variations 1 through 7 and may further include providing a performance manager module constructed and arranged to monitor at least one actuator subsystem and communicate a health status of the at least one actuator subsystem to the motion monitoring diagnostic module.

Variation 9 may include a method as set forth in any of variations 1 through 8 and may further include providing a vehicle dynamic response data module constructed and arrange to communicate vehicle responses to the motion monitoring diagnostic module.

Variation 10 may include a method as set forth in any of variations 1 through 9 wherein the motion monitoring diagnostic module may be constructed and arranged to receive information from the vehicle performance manager module and the vehicle dynamic response data module to determine vehicle motion plausibility status.

Variation 11 may include a method as set forth in any of variations 1 through 10 and may further include providing a motion control request arbitration module which, in cooperation with information received from the motion monitoring diagnostic module and the functional safety manager module, may be constructed and arranged to determine if the first motion control algorithm's motion control requests are within a plausible range.

According to variation 12, a product may include a first motion control algorithm and a second motion control algorithm, the first motion control algorithm and a second motion control algorithm being constructed and arranged to provide motion control requests; a motion monitoring diagnostic module; a functional safety manager module; and a motion control request arbitration module constructed and arranged to determine if the first motion control algorithm's motion control requests are within a plausible range in cooperation with information received from the motion monitoring diagnostic module and the functional safety manager module.

Variation 13 may include a product as set forth in variation 12 and may further include a motion control path planner constructed and arranged to communicate trajectory commands to at least one of the first motion control algorithm or the second motion control algorithm.

Variation 14 may include a product as set forth in any of variations 12 through 13 and may further include at least one actuator subsystem that may include at least one actuator.

Variation 15 may include a product as set forth in any of variations 12 through 14 and may further include a safety limiter module constructed and arranged to apply motion control request limits in cooperation with the functional safety manager module.

Variation 16 may include a product as set forth in any of variations 12 through 13 wherein the motion monitoring diagnostic module may be constructed and arranged to determine vehicle motion plausibility data and communicate the vehicle motion plausibility data to the functional safety manager module.

Variation 17 may include a product as set forth in any of variations 12 through 16 and may further include a performance manager module constructed and arranged to monitor the at least one actuator subsystem and communicate a health status of the at least one actuator subsystem to the motion monitoring diagnostic module.

Variation 18 may include a product as set forth in any of variations 12 through 17 and may further include a vehicle dynamic response data module constructed and arrange to communicate vehicle responses to the motion monitoring diagnostic module.

Variation 19 may include a product as set forth in any of variations 12 through 18 wherein the motion monitoring diagnostic module may be constructed and arranged to receive information from the vehicle performance manager module and the vehicle dynamic response data module to determine vehicle motion plausibility status.

According to variation 20, a product may include a first motion control algorithm and a second motion control algorithm, the first motion control algorithm and a second motion control algorithm being constructed and arranged to provide motion control requests; a motion control path planner constructed and arranged to communicate trajectory commands to at least one of the first motion control algorithm or the second motion control algorithm; a functional safety manager module; a motion monitoring diagnostic module constructed and arranged to determine vehicle motion plausibility data and communicate the vehicle motion plausibility data to the functional safety manager module; and a motion control request arbitration module constructed and arranged to determine if the first motion control algorithm's motion control requests are within a plausible range.

The above description of select variations within the scope of the invention is merely illustrative in nature and, thus, variations or variants thereof are not to be regarded as a departure from the spirit and scope of the invention.

What is claimed is:

1. A method comprising:
providing a motion control system;
providing a first motion control algorithm and a second motion control algorithm, the first motion control algorithm and a second motion control algorithm being constructed and arranged to provide motion control requests;
determining if the first motion control algorithms motion control requests are within a plausible range; and
performing a switchover from the first motion control algorithm to the second motion control algorithm within the motion control system if the first motion control algorithms motion control requests are outside of the plausible range such that the motion control system reduces errant output behavior.

2. A method as set forth in claim 1, further comprising:
defining the plausible range prior to determining if the first motion control algorithms motion control requests are within the plausible range.

3. A method as set forth in claim 1, further comprising:
providing a motion control path planner constructed and arranged to communicate trajectory commands to at least one of the first motion control algorithm or the second motion control algorithm.

4. A method as set forth in claim 1, further comprising:
providing a motion control request arbitration module constructed and arranged to arbitrate motion requests made by the at least one of the first motion control algorithm or the second motion control algorithm.

5. A method as set forth in claim 1, further comprising:
providing at least one actuator subsystem comprising at least one actuator.

6. A method as set forth in claim 5, further comprising:
providing a safety limiter module and a functional safety manager module constructed and arranged to apply motion control request limits.

7. A method as set forth in claim 6, further comprising;
providing a motion monitoring diagnostic module constructed and arranged to determine vehicle motion plausibility data and communicate the vehicle motion plausibility data to the functional safety manager module.

8. A method as set forth in claim 7, further comprising:
providing a performance manager module constructed and arranged to monitor at least one actuator subsystem and communicate a health status of the at least one actuator subsystem to the motion monitoring diagnostic module.

9. A method as set forth in claim 7, further comprising:
providing a vehicle dynamic response data module constructed and arranged to communicate vehicle responses to the motion monitoring diagnostic module.

10. A method as set forth in claim 9, wherein the motion monitoring diagnostic module is constructed and arranged to receive information from the vehicle performance manager module and the vehicle dynamic response data module to determine vehicle motion plausibility status.

11. A method as set forth in claim 10, further comprising:
providing a motion control request arbitration module which, in cooperation with information received from the motion monitoring diagnostic module and the functional safety manager module, is constructed and arranged to determine if the first motion control algorithm's motion control requests are within a plausible range.

12. A product comprising:
a first motion control algorithm and a second motion control algorithm, the first motion control algorithm and a second motion control algorithm being constructed and arranged to provide motion control requests;
a motion monitoring diagnostic module;
a functional safety manager module; and
a motion control request arbitration module constructed and arranged to determine if the first motion control algorithm's motion control requests are within a plausible range in cooperation with information received from the motion monitoring diagnostic module and the functional safety manager module.

13. A product as set forth in claim 12, further comprising:
a motion control path planner constructed and arranged to communicate trajectory commands to at least one of the first motion control algorithm or the second motion control algorithm.

14. A product as set forth in claim 12, further comprising:
at least one actuator subsystem comprising at least one actuator.

15. A product as set forth in claim 14, further comprising:
a safety limiter module constructed and arranged to apply motion control request limits in cooperation with the functional safety manager module.

16. A product as set forth in claim 15, wherein the motion monitoring diagnostic module is constructed and arranged to determine vehicle motion plausibility data and communicate the vehicle motion plausibility data to the functional safety manager module.

17. A product as set forth in claim 16, further comprising:
a performance manager module constructed and arranged to monitor the at least one actuator subsystem and communicate a health status of the at least one actuator subsystem to the motion monitoring diagnostic module.

18. A method as set forth in claim 17, further comprising:
a vehicle dynamic response data module constructed and arrange to communicate vehicle responses to the motion monitoring diagnostic module.

19. A method as set forth in claim 18, wherein the motion monitoring diagnostic module is constructed and arranged to receive information from the vehicle performance manager module and the vehicle dynamic response data module to determine vehicle motion plausibility status.

20. A product comprising:
a first motion control algorithm and a second motion control algorithm, the first motion control algorithm and a second motion control algorithm being constructed and arranged to provide motion control requests;
a motion control path planner constructed and arranged to communicate trajectory commands to at least one of the first motion control algorithm or the second motion control algorithm;
a functional safety manager module;
a motion monitoring diagnostic module constructed and arranged to determine vehicle motion plausibility data and communicate the vehicle motion plausibility data to the functional safety manager module; and
a motion control request arbitration module constructed and arranged to at least one of:
determine if the first motion control algorithm's motion control requests are within a plausible range;
arbitrate motion requests made by the at least one of the first motion control algorithm or the second motion control algorithm; or
perform a switchover from the first motion control algorithm to the second motion control algorithm within the motion control system if the first motion control algorithms motion control requests are outside of the plausible range such that the motion control system reduces errant output behavior.
